(19) United States
(12) Patent Application Publication
(10) Pub. No.: US 2022/0200011 A1
(43) Pub. Date: Jun. 23, 2022

(54) Gas Diffusion Layer Structure for Fuel Cell

(71) Applicants: Hyundai Motor Company, Seoul (KR); Kia Corporation, Seoul (KR)

(72) Inventor: Sung Ho Lee, Seongnam-si (KR)

(21) Appl. No.: 17/443,602

(22) Filed: Jul. 27, 2021

(30) Foreign Application Priority Data
Dec. 23, 2020 (KR) 10-2020-0181728

(51) Int. Cl. H01M 4/88; H01M 8/1004; H01M 8/04119; H01M 8/0258

(52) U.S. Cl. CPC H01M 4/8807; H01M 8/0258; H01M 8/04149; H01M 8/1004

(57) ABSTRACT

An embodiment gas diffusion layer structure of a unit cell of a fuel cell includes a catalyst layer of the unit cell of the fuel cell, a separator of the unit cell of the fuel cell, and a gas diffusion layer disposed between the catalyst layer and the separator. An embodiment gas diffusion layer includes a carbon substrate layer, a microporous layer, a catalyst layer neighboring region neighboring the catalyst layer, the catalyst layer neighboring region including the microporous layer, and a gas channel neighboring region neighboring the separator, the gas channel neighboring region including the carbon substrate layer, wherein a solid volume fraction of the gas channel neighboring region is configured to increase to a target solid volume fraction.

### CROSS-REFERENCE TO RELATED APPLICATIONS

The application claims the benefit of Korean Patent Application No. 10-2020-0181728, filed Dec. 23, 2020, which application is hereby incorporated herein by reference.

### TECHNICAL FIELD

The present disclosure relates to a fuel cell.

### BACKGROUND

A unit cell of a fuel cell includes a polymer electrolyte membrane, an air electrode (cathode) and a fuel electrode (anode). The air electrode and the fuel electrode are electrode catalyst layers, applied to opposite sides of the electrolyte membrane such that hydrogen and oxygen react with each other. The unit cell also includes gas diffusion layers (GDLs) stacked outside the air electrode and the fuel electrode, and a separator stacked outside the gas diffusion layer to supply fuel and discharge water generated as the result of reaction.

The gas diffusion layers (GDLs) support the air electrode and the fuel electrode, which are the catalyst layers, and each gas diffusion layer includes a carbon substrate and a microporous layer (MPL). The gas diffusion layer (GDL) functions to (a) transfer a reaction gas to the catalyst layer to evenly distribute the reaction gas in the catalyst layer, (b) discharge water generated from an electrochemical reaction in the catalyst layer, and (c) transfer electricity and heat generated at the catalyst layer.

Among the functions (a) to (c) of the gas diffusion layer (GDL), the functions (a) and (b) are opposed to or conflict with the function (c). If pores of the gas diffusion layer (GDL) are made larger, gas diffusion is accelerated, but thermal and electric resistances increase as thermal and electric conduction paths are reduced. In contrast, if the conduction path in the gas diffusion layer (GDL) is increased to improve thermal and electrical conductivity, pores become reduced.

Therefore, there is a need for the structure of a gas diffusion layer having high thermal and electrical conductivity, as well as high material transport ability.

The foregoing is intended merely to aid in the understanding of the background of the present disclosure, and is not intended to mean that the present disclosure falls within the purview of the related art that is already known to those skilled in the art.

Korean Patent Application Publication No. 10-2020-0031845 (Publication Date: 2020 Mar. 25) describes information related to the present subject matter.

### SUMMARY

The present disclosure relates to a fuel cell. Particular embodiments relate to a structure of a gas diffusion layer included in a unit cell of a fuel cell.

Embodiments of the present disclosure can solve problems.

An embodiment of the present invention provides a gas diffusion layer structure of a fuel cell having high gas diffusion performance and high thermal and electric conductivities.

The embodiments of the present invention are not limited to those described above, and other unmentioned embodiments of the present invention will be clearly understood by a person of ordinary skill in the art from the following description.

The features of embodiments of the present invention to accomplish the embodiments of the present invention and to perform characteristic functions of embodiments of the present invention, a description of which will follow, are as follows.

One embodiment of the present invention provides a gas diffusion layer structure of a unit cell of a fuel cell comprising a gas diffusion layer disposed between a catalyst layer and a separator of the unit cell of the fuel cell, the gas diffusion layer comprising a carbon substrate layer and a microporous layer, wherein the gas diffusion layer comprises a catalyst layer neighboring region neighboring the catalyst layer, the catalyst layer neighboring region comprising the microporous layer, and a gas channel neighboring region neighboring the separator, the gas channel neighboring region comprising the carbon substrate layer, and the gas diffusion layer being made such that a solid volume fraction of the gas channel neighboring region increases to a target solid volume fraction.

Other aspects and preferred embodiments of the invention are discussed infra.

The above and other features of embodiments of the invention are discussed infra.

It is understood that the term “vehicle” or “vehicular” or other similar term as used herein is inclusive of motor vehicles in general such as passenger automobiles including sport utility vehicles (SUVs), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles, e.g., fuels derived from resources other than petroleum. As referred to herein, a hybrid vehicle is a vehicle that has two or more sources of power, for example both gasoline-powered and electric-powered vehicles.

### BRIEF DESCRIPTION OF THE DRAWINGS

FIG. 1 is a sectional view of a unit fuel cell according to embodiments of the present invention;

FIG. 2 shows the solid volume fraction of a gas diffusion layer over a thickness direction of the gas diffusion layer;

FIG. 3 compares the solid volume fraction over thickness of a gas diffusion layer between FIG. 2 and the gas diffusion layer structure according to embodiments of the present invention;

FIG. 4 shows the solid volume fraction of a gas channel neighboring region before and after compression according to some embodiments of the present invention;

FIG. 5 shows the porosity of a gas channel neighboring region before and after compression according to some embodiments of the present invention;

FIG. 6 shows change in porosity of the gas diffusion layer in the thickness direction; and

FIG. 7 shows change in conduction area of the gas diffusion layer depending on the change in porosity.

### DETAILED DESCRIPTION OF ILLUSTRATIVE EMBODIMENTS

Hereinafter, preferred embodiments of the present disclosure will be described in detail with reference to the accompanying drawings. Specific structures or functions described in the embodiments of the present disclosure are merely for illustrative purposes. Embodiments according to the concept of the present disclosure may be implemented in various forms, and it should be understood that they should not be construed as being limited to the embodiments described in the present specification, but include all of modifications, equivalents, or substitutes included in the spirit and scope of the present disclosure.

It will be understood that, although the terms “first,” “second,” etc., may be used herein to describe various elements, these elements should not be limited by these terms. These terms are only used to distinguish one element from another element. For instance, a first element discussed below could be termed a second element without departing from the teachings of embodiments of the present invention. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,” “directly between,” “adjacent to,” or “directly adjacent to,” should be construed in the same way.

Like reference numerals denote like components throughout the specification. In the meantime, the terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise,” “include,” “have,” etc., when used in this specification, specify the presence of stated components, steps, operations, and/or elements, but do not preclude the presence or addition of one or more other components, steps, operations, and/or elements thereof.

Hereinafter, embodiments of the present disclosure will be described in detail with reference to the accompanying drawings.

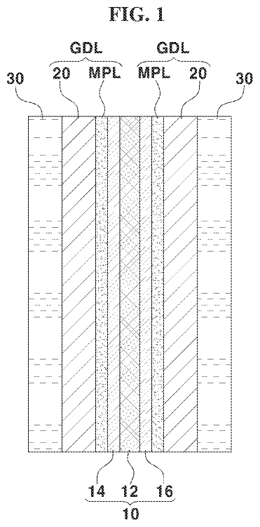

As shown in FIG. 1, a unit cell in a fuel cell includes a membrane-electrode assembly 10. The membrane-electrode assembly 10 includes a polymer electrolyte membrane 12 configured to move hydrogen protons and an air electrode (cathode) 14 and a fuel electrode (anode) 16, which are catalyst layers, applied to opposite surfaces of the polymer electrolyte membrane 12 such that hydrogen and oxygen react with each other.

Gas diffusion layers GDLs are stacked outside the membrane-electrode assembly 10, i.e., outside the air electrode 14 and the fuel electrode 16, respectively. A separator 30 having one or more channels configured to supply fuel and discharge water generated from the reaction is disposed outside each gas diffusion layer GDL.

The gas diffusion layer GDL includes a substrate layer 20 including carbon fibers and a microporous layer MPL provided at one side of the substrate layer 20.

The substrate layer 20 generally includes carbon fibers and hydrophobic material. As a non-limiting example, a carbon fiber cloth, carbon fiber felt, or carbon fiber paper may be used as the substrate layer 20.

The microporous layer MPL may be manufactured by mixing carbon powders, such as carbon black, with a hydrophobic material. The microporous layer MPL may be applied to one surface of the substrate layer 20 depending on the purpose of use.

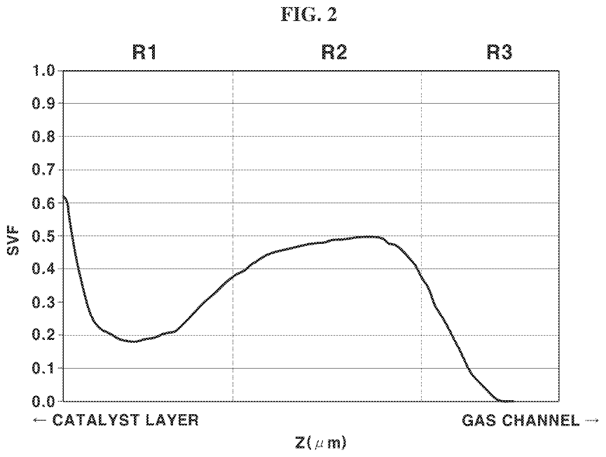

FIG. 2 shows a change in solid volume fraction SVF of the gas diffusion layer GDL depending on the position of the gas diffusion layer GDL in a thickness direction. The x-axis indicates the position z in the thickness direction, and that the catalyst layer side has a thickness of 0 and the thickness gradually increases in a rightward direction is shown as an example.

As shown in FIG. 2, the gas diffusion layer GDL may be roughly divided into three regions in consideration of the solid volume fraction of the gas diffusion layer GDL depending on the position of the gas diffusion layer GDL in the thickness direction. The three regions will be referred to as a catalyst layer neighboring region R1, a substrate layer center region R2, and a gas channel neighboring region R3. The catalyst layer neighboring region R1 is mainly constituted by the microporous layer MPL and neighbors one of the catalyst layers, the air electrode 14 or the fuel electrode 16. The substrate layer center region R2 is the central portion of the substrate layer 20. The gas channel neighboring region R3 neighbors a gas channel formed in the separator 30.

The solid volume fraction SVF is high at the portion of the catalyst layer neighboring region R1 that is very close to the catalyst layer and at the substrate layer center region R2, and is low at the gas channel neighboring region R3. That is, when describing in terms of density, the gas diffusion layer GDL has the lowest density at the gas channel neighboring region R3, which means that a path along which electricity or heat passes is the narrowest at the gas channel neighboring region R3. That is, resistance is so high at the gas channel neighboring region R3 that a bottleneck phenomenon of conduction can be observed in the thickness direction.

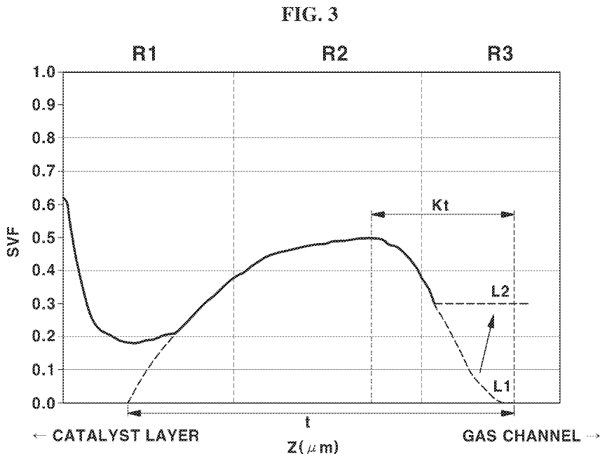

In embodiments of the present invention, as shown in FIG. 3, the solid volume fraction SVF of the gas channel neighboring region R3, at which solid volume distribution is quite low, is increased from L1 to L2 in order to improve effective conductivity. According to embodiments of the present invention, the substrate layer 20 is further reinforced for the gas channel neighboring region R3 in order to increase conductivity.

According to embodiments of the present invention, the solid volume fraction SVF of the gas channel neighboring region R3 is increased. In general, at the time of manufacturing the gas diffusion layer GDL, the substrate layer 20 is prepared first and then the microporous layer MPL is provided. When carbon fibers are stacked in the early stage of formation of the substrate layer 20, the density of the substrate layer 20 decreases. This essentially happens when the number of carbon fibers added becomes 0; when carbon fibers with a certain length are stacked, the number of carbon fibers added decreases from the late stage of stacking to completion and becomes 0 when no more carbon fibers are added. In order to change this, according to some embodiments of the present invention, a binder is additionally injected after formation of the gas diffusion layer GDL to increase the solid volume fraction SVF. That is, the binder is additionally injected after both the microporous layer MPL and the substrate layer 20 are formed. According to some embodiments of the present invention, more carbon fibers are added than in a conventional case in the late stage of the process of stacking the carbon fibers at the time of manufacture of the substrate layer 20 in order to increase the solid volume fraction SVF. That is, the number of carbon fibers to be added is predetermined in advance based on a target solid volume fraction SVF and/or a target porosity to be acquired at the gas channel neighboring region, and then the predetermined number of carbon fibers is stacked. According to some embodiments of the present invention, the above two embodiments are combined. That is, additional injection of the binder and additional addition of carbon fibers are simultaneously performed at the time of manufacturing the gas diffusion layer GDL.

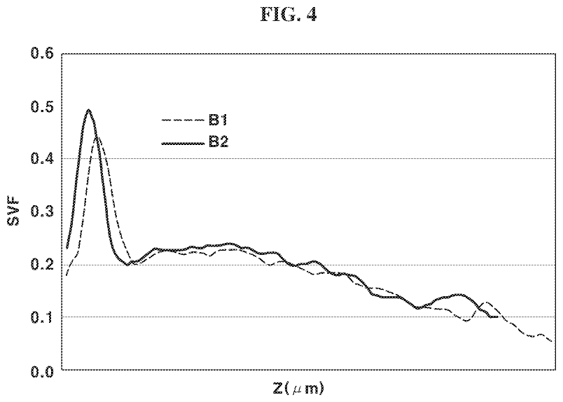

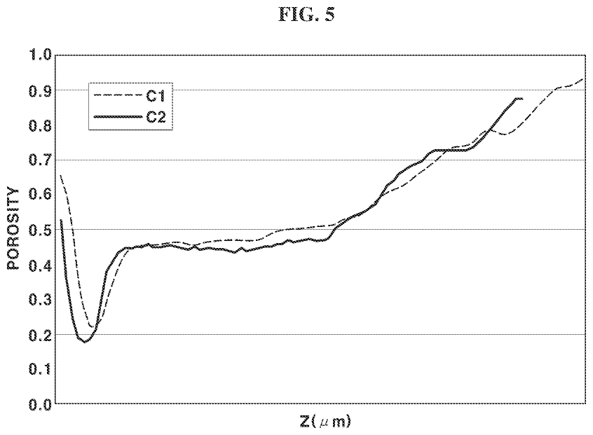

According to some embodiments of the present invention, the gas diffusion layer GDL is manufactured thicker than in a conventional case and compressed before use in order to increase the solid volume fraction SVF. When the gas diffusion layer GDL is compressed, a low-density region having low rigidity or the gas channel neighboring region R3 is deformed first. As shown in FIG. 4, therefore, a prior dotted line (before additional compression) B1 is changed to a solid line (after additional compression) B2, whereby the solid volume fraction SVF is increased. As a result, as shown in FIG. 5, porosity is also generally reduced from a prior dotted line (before additional compression) C1 is changed to a solid line (after additional compression) C2.

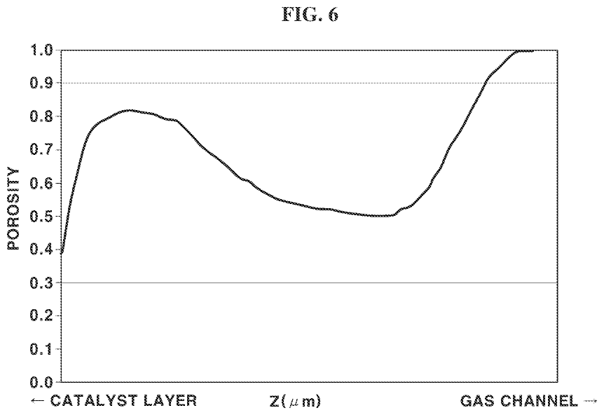

As shown in FIG. 6, in many cases, porosity exceeds about 90% at the gas channel neighboring region R3 or the portion of the gas channel neighboring region R3 that is proximate to the gas channel. The porosity is not greatly reduced even when being compressed in the process of fastening to the separator. This means that a path for transferring heat or electricity is about 10% of the total area and thus a conduction path is not greatly increased even when being compressed.

According to embodiments of the present invention, therefore, it is expected that, as porosity is reduced by 10%, conduction area is increased from 10% to 20% (100% increase), whereby it is possible to greatly increase conductivity. That is, for example, in a case in which the porosity is reduced from 90% to 80%, the solid volume fraction SVF may be increased from 10% to 20%.

That is, according to embodiments of the present invention, a gas diffusion layer GDL structure having increased solid volume fraction SVF on the surface opposite the microporous layer MPL is included, whereby it is possible to improve conductivity.

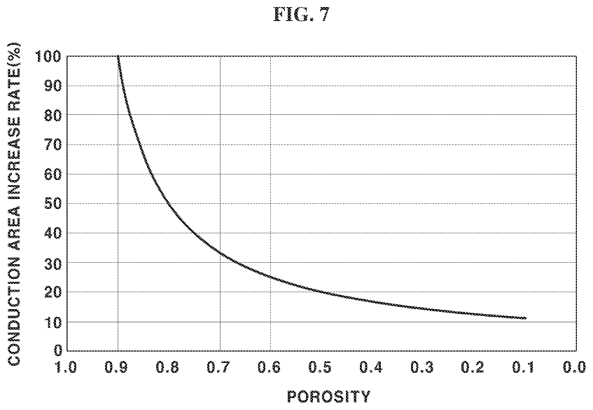

Referring to FIG. 7, porosity p and solid volume fraction SVF in the gas diffusion layer GDL have an inversely proportional relationship, as in Equation 1, and are inversely proportional to each other within a range of 0 to 1.

SVF=1−p (1)

Referring back to FIGS. 2 and 6, there is a tendency in which porosity abruptly increases and solid volume fraction SVF approximates to 0 at the gas channel neighboring region R3. To see from another point of view, a small decrease in porosity may cause an exceptionally large increase in solid volume fraction SVF.

Further referring to Table 1, change in solid volume fraction SVF corresponding to conduction area is shown when porosity within a range of about 0.98 to 0.1 is reduced by 10%.

For example, when the porosity p decreases by 10% from 0.95 to 0.85, the solid volume fraction SVF increases by about 200% from 0.05 to 0.15, whereby solid volume fraction is tripled.

In the vicinity of the gas channel neighboring region R3 of the gas diffusion layer GDL at which the porosity exceeds 0.9 and increases to 0.95 or more, it is possible to greatly increase the conduction area through slight reduction in porosity, thereby increasing effective conductivity.

TABLE 1

| | Solid volume fraction | Conduction area increase |
|---|---|---|
| Porosity (p) | (SVF) | rate (%) |
| 0.98 | 0.02 | 400 |
| 0.95 | 0.05 | 200 |
| 0.90 | 0.10 | 100 |
| 0.85 | 0.15 | 67 |
| 0.80 | 0.20 | 50 |
| 0.75 | 0.25 | 40 |
| 0.70 | 0.30 | 33 |
| 0.65 | 0.35 | 29 |
| 0.60 | 0.40 | 25 |
| 0.55 | 0.45 | 22 |
| 0.50 | 0.50 | 20 |
| 0.45 | 0.55 | 18 |
| 0.40 | 0.60 | 17 |
| 0.35 | 0.65 | 15 |
| 0.30 | 0.70 | 14 |
| 0.25 | 0.75 | 13 |
| 0.20 | 0.80 | 13 |
| 0.15 | 0.85 | 12 |
| 0.10 | 0.90 | 11 |

According to embodiments of the present invention, the porosity p at the gas channel neighboring region R3 is reduced to about 0.7 or less. Referring back to FIG. 6, since the porosity generally used in the fuel cell at the gas channel neighboring region R3 is about 0.6 to 0.8, the porosity p is reduced to approximately 0.6 to 0.8, preferably 0.7, in the gas channel neighboring region R3.

There is a time when porosity distribution of the gas diffusion layer GDL reaches about 0.5 even at the substrate layer 20, and very small porosity is exhibited even at the border where the microporous layer MPL is adjacent to the catalyst layer. It is observed that decrease in the porosity of the gas channel neighboring region R3 to about 0.7 barely affects gas diffusion and transmission; decrease in porosity may not affect transmission capability.

Referring back to FIG. 3, according to embodiments of the present invention, the solid volume fraction SVF of the substrate layer 20 belonging to a predetermined range kt (k being greater than 0 and less than 1) of the thickness t of the substrate layer 20 is increased. According to an embodiment of the present invention, k of the predetermined range kt is about 0.3 to 0.5. That is, about 30 to 50% of the thickness of the substrate layer 20 at the side of the gas channel of the separator 30 becomes a thickness correction target, whereby it is possible to improve thermal and electrical conductivities while maintaining gas diffusion performance. That is, the gas channel neighboring region R3, which is the correction target, occupies 30 to 50% of the thickness t of the entire substrate layer 20.

It should be understood that the present disclosure is not limited to the above described embodiments and the accompanying drawings, and various substitutions, modifications, and alterations can be devised by those skilled in the art without departing from the technical spirit of the present disclosure.

What is claimed is:

1. A gas diffusion layer structure of a unit cell of a fuel cell, the gas diffusion layer structure comprising:
a catalyst layer of the unit cell of the fuel cell;
a separator of the unit cell of the fuel cell; and
a gas diffusion layer disposed between the catalyst layer and the separator, the gas diffusion layer comprising:
a carbon substrate layer;
a microporous layer;
a catalyst layer neighboring region neighboring the catalyst layer, the catalyst layer neighboring region comprising the microporous layer; and
a gas channel neighboring region neighboring the separator, the gas channel neighboring region comprising the carbon substrate layer, wherein a solid volume fraction of the gas channel neighboring region is configured to increase to a target solid volume fraction.

2. The gas diffusion layer structure according to claim 1, wherein the gas diffusion layer has a thickness greater than a predetermined thickness and is compressed.

3. The gas diffusion layer structure according to claim 1, wherein the target solid volume fraction is determined based on porosity distribution of the gas diffusion layer.

4. The gas diffusion layer structure according to claim 1, wherein the gas channel neighboring region occupies 30 to 50% of a thickness of the carbon substrate layer.

5. A method of making the gas diffusion layer structure according to claim 1, wherein the gas diffusion layer structure is made by injecting a binder into the gas channel neighboring region after manufacture of the gas diffusion layer.

6. A method of making the gas diffusion layer structure according to claim 1, wherein the gas diffusion layer structure is made by stacking carbon fibers in an amount set in advance based on the target solid volume fraction when manufacturing the carbon substrate layer.

7. A method of making the gas diffusion layer structure according to claim 1, wherein the gas diffusion layer structure is made by injecting a binder into the gas channel neighboring region after manufacture of the gas diffusion layer and stacking carbon fibers in an amount set in advance based on the target solid volume fraction when manufacturing the carbon substrate layer.

8. A unit cell of a fuel cell, the unit cell comprising:
a catalyst layer;
a separator;
a gas diffusion layer disposed between the catalyst layer and the separator, the gas diffusion layer comprising:
a carbon substrate layer;
a microporous layer;
a catalyst layer neighboring region neighboring the catalyst layer, the catalyst layer neighboring region comprising the microporous layer; and
a gas channel neighboring region neighboring the separator, the gas channel neighboring region comprising the carbon substrate layer, wherein a solid volume fraction of the gas channel neighboring region is configured to increase to a target solid volume fraction, wherein the solid volume fraction of the gas channel neighboring region is inversely proportional to a porosity of the gas channel neighboring region, and wherein each of the solid volume fraction and the porosity is set within a range of 0 to 1.

9. The unit cell according to claim 8, wherein a range of the porosity comprises a low region and a high region having a porosity value greater than the low region, wherein, when the porosity decreases by a first value in the low region or the high region, the solid volume fraction increases by a second value in the high region, and the solid volume fraction increases by a third value in the low region, the second value being greater than the third value.

10. The unit cell according to claim 9, wherein the high region of the porosity is 0.7 to 1.

11. The unit cell according to claim 10, wherein, when the first value is 0.1 in the high region, the second value is 1.5 or more times and less than 5 times the first value.

12. The unit cell according to claim 9, wherein the low region of the porosity is 0.4 to less than 0.7, and when the first value is 0.1 in the low region, the third value is 1.2 or more times and 1.3 or less times the first value.

13. The unit cell according to claim 9, wherein the high region of the porosity is 0.8 to 1, and when the first value is 0.1 within the high region, the second value is 2 or more times and less than 5 times the first value.

14. The unit cell according to claim 13, wherein the high region of the porosity is 0.85 to 1, and when the first value is 0.1 in the high region, the second value is 3 or more times and less than 5 times the first value.

15. A method of forming a unit cell of a fuel cell, the method comprising:
forming a membrane-electrode assembly comprising a polymer electrolyte membrane, a first catalyst layer on a first surface of the polymer electrolyte membrane, and a second catalyst layer on a second, opposite surface of the polymer electrolyte membrane;
forming a gas diffusion layer comprising:
forming a microporous layer on an outer surface of the first catalyst layer, wherein the microporous layer includes a catalyst layer neighboring region; and
forming a carbon substrate layer on an outer surface of the microporous layer, wherein the carbon substrate layer includes a gas channel neighboring region, and wherein a solid volume fraction of the gas channel neighboring region is configured to increase to a target solid volume fraction;
injecting a binder into the gas channel neighboring region after forming the gas diffusion layer; and
forming a separator on the gas diffusion layer.

16. The method according to claim 15, wherein forming the carbon substrate layer comprises stacking carbon fibers in an amount set in advance based on the target solid volume fraction.

17. The method according to claim 15, wherein the gas diffusion layer has a thickness greater than a predetermined thickness.

18. The method according to claim 17, further comprising compressing the gas diffusion layer.

19. The method according to claim 15, wherein the target solid volume fraction is determined based on porosity distribution of the gas diffusion layer.

20. The method according to claim 15, wherein the gas channel neighboring region occupies 30 to 50% of a thickness of the carbon substrate layer.
